(19) United States
(12) Patent Application Publication
(10) Pub. No.: US 2025/0251064 A1
(43) Pub. Date: Aug. 7, 2025

(54) NUT TYPE ROTATABLE FLANGE STRUCTURE AND COMBINATION TOOL

(71) Applicant: Southwestern Institute of Physics, Chengdu (CN)

(72) Inventors: Yong LI, Chengdu (CN); Fangzheng ZHA, Chengdu (CN); Jun LI, Chengdu (CN)

(21) Appl. No.: 18/293,667

(22) PCT Filed: Nov. 17, 2021
(86) PCT No.: PCT/CN2021/131096

§ 371 Date: Jan. 30, 2024

(30) Foreign Application Priority Data
Oct. 28, 2021 (CN) 202111265125.3

(51) Int. Cl. F16L 23/036; B25B 13/50; F16L 23/032

(52) U.S. Cl. CPC F16L 23/036; B25B 13/50; F16L 23/032

(57) ABSTRACT

Provided are a nut type rotatable flange structure and a combination tool. Flanges of a first neck flange and a second neck flange are both arranged in a nut loop, one of the flanges is secured by using a thread, and the other flange is secured by using push screws, so that the flanges of the first neck flange and the second neck flange are hermetically and stably fixed, instead of a method of aligning a transmission flange hole with a flange hole and then screwing in a bolt to achieve connection. In general, the nut type rotatable flange structure and the combination tool can achieve the hermetical connection between the flanges, with no need to use a conventional method of connecting a plurality of flange holes to a plurality of flange holes, which not only reduces requirements for mounting accuracy, but also can achieve better disassembly and mounting.

### CROSS-REFERENCE TO RELATED APPLICATIONS

This application is the U.S. national stage application of International Patent Application No. PCT/CN2021/131096, filed Nov. 17, 2021, which claims the benefit under 35 U.S.C. § 119 of Chinese Application No. 202111265125.3, filed Oct. 28, 2021, the disclosures of each of which are incorporated herein by reference in their entirety.

### TECHNICAL FIELD

The present invention relates to the technical field of flange connection, and in particular, to a nut type rotatable flange structure and a combination tool.

### BACKGROUND

Currently, pipelines are generally connected by using flanges formed at ends of the pipelines. Flanges of two pipelines are aligned with each other, and after the alignment, two aligned screw hole portions are secured together through fit of bolts and nuts, thus completing fixed connection between the flanges of the two pipelines. This conventional flange connection method relies more on alignment accuracy between flange holes to achieve more stable bolted connection. Once machining accuracy between the flange holes decreases or the alignment accuracy there between is not high, unstable connection between pipelines is likely to occur.

In view of this, the present application is provided.

### SUMMARY

An objective of the present invention is to provide a nut type rotatable flange structure and a combination tool. The flange structure and the combination tool replace a conventional method of aligning two holes, that is, two flanges can be stably connected to each other while stable sealing is ensured.

Embodiments of the present invention are implemented as follows.

In a first aspect, a nut type rotatable flange structure includes a nut loop, a first neck flange, a second neck flange, and push screws, where a connecting thread is machined on an inner surface of one end of the nut loop, an annular protruding edge is formed on an inner surface of the other end of the nut loop, and threaded through holes are machined in the annular protruding edge in an axial direction of the nut loop; a neck of the first neck flange passes through an inner hole of the annular protruding edge, an outer surface of the neck fits with the inner hole of the annular protruding edge, a flange portion of the first neck flange is located in an inner hole of the nut loop, and an outer surface of the flange portion fits with the inner hole of the nut loop; an external thread is machined on an outer surface of a flange portion of the second neck flange, the flange portion fits with the connecting thread of the nut loop by using the external thread of the flange portion, and a sealing member is arranged between the flange portion of the second neck flange and the flange portion of the first neck flange; and the push screws are in threaded fit with the threaded through holes in the annular protruding edge, and threaded ends of the push screws can act on the flange portion of the first neck flange, so that the flange portion of the first neck flange, the flange portion of the second neck flange and the sealing member are hermetically connected to each other.

In an optional implementation, the nut type rotatable flange structure further includes a hard washer, where the hard washer is sleeved on the neck of the first neck flange, and the hard washer is abutted against between the threaded end of the push screw and the flange portion of the first neck flange.

In an optional implementation, the inner hole of the nut loop includes an internal thread section, a tool withdrawal groove section and a protruding edge fitting section that are sequentially connected; and the internal thread section is configured to form the connecting thread, the tool withdrawal groove section is configured to fit with the flange portion of the first neck flange and the hard washer, a washer fitting section is configured to fit with the hard washer, and the protruding edge fitting section is configured to form the annular protruding edge.

In an optional implementation, a solid lubricant coating is arranged on an end surface of at least one side of the hard washer.

In an optional implementation, a thread rotation direction of the connecting thread is opposite to a thread rotation direction of the threaded through hole, a minimum clearance of fit between the threaded through hole and the push screw is a first clearance, a minimum clearance of fit between the connecting thread and the external thread of the flange portion of the second neck flange is a second clearance, and the size of the first clearance is greater than the size of the second clearance; and
the solid lubricant coating can generate elastic deformation in an axial direction of the hard washer, and when the solid lubricant coating is arranged on an end surface of one side of the hard washer, a maximum deformation quantity of the elastic deformation generated by the solid lubricant coating on the one side is not less than a sum of the sizes of the first clearance and the second clearance; or when each of end surfaces of two sides of the hard washer is arranged with the solid lubricant coating, a maximum total deformation quantity of the elastic deformation generated by the solid lubricant coatings on the two sides is not less than the sum of the sizes of the first clearance and the second clearance.

In an optional implementation, positioning grooves are formed in one side of the flange portion of the first neck flange and one side of the flange portion of the second neck flange that are close to each other, a positioning space for accommodating the sealing member is formed between the two positioning grooves, and the sealing member is secured to the positioning groove in at least one side by using a connecting member.

In an optional implementation, a plurality of threaded through holes are provided, and the plurality of threaded through holes are evenly distributed on the annular protruding edge around an axis of the nut loop in a circumferential direction; a number of the push screws is equal to a number of the threaded through holes, and single push screws are in threaded fit with single threaded through holes.

In an optional implementation, a boss portion that can interact with a wrench is formed on an outer surface of a neck of the second neck flange; and/or a boss portion that can interact with a wrench is formed on an outer surface of the nut loop.

In a second aspect, a nut type rotatable flange combination tool includes an operating wrench and the above-mentioned nut type rotatable flange structure, where the nut type rotatable flange structure is provided with a plurality of threaded through holes, and the plurality of threaded through holes are evenly distributed on an annular protruding edge around an axis of a nut loop in a circumferential direction; a number of push screws is equal to a number of the threaded through holes, and single push screws are in threaded fit with single threaded through holes; the operating wrench includes an operating portion and a positioning portion connected to the operating portion, and the positioning portion can be secured to at least two push screws; and a boss portion that can interact with a wrench is formed on an outer surface of a neck of a second neck flange.

In an optional implementation, at least two positioning holes are machined in the positioning portion, and the at least two positioning holes can be correspondingly sleeved with a same number of push screws simultaneously.

The embodiments of the present invention have the following beneficial effects:

In the nut type rotatable flange structure according to the embodiments of the present invention, the first neck flange and the second neck flange are arranged in the nut loop, and the two neck flanges are mutually positioned accurately and limited in the inner hole of the nut loop. Therefore, on the one hand, a constraint space can be formed, and the flanges on two sides can be positioned accurately, which replaces a conventional method of aligning holes; and on the other hand, operation convenience is greatly improved, and the flanges on the two sides only need to be placed in the inner hole of the nut loop, without using a conventional complicated method of matching and positioning a plurality of holes with a plurality of holes. In addition, through the arrangement of the push screws in the annular protruding edge of the nut loop, the flanges on the two sides can abut against each other, thus achieving a hermetical and stable connection.

In addition, in the nut type rotatable flange combination tool according to the embodiments of the present invention, based on the above-mentioned nut type rotatable flange structure, a force can be applied to secure the nut loop by providing the matching operating wrench, thereby facilitating the connection between the flanges on the two sides and other structures, facilitating the connection with other structures based on the hermetical connection between the flanges, and achieving higher operability.

Generally, the nut type rotatable flange structure and the combination tool according to the embodiments of the present invention can achieve the hermetical connection between the flanges, with no need to use the conventional method of connecting a plurality of flange holes to a plurality of flange holes, which not only reduces requirements for mounting accuracy and improves operation convenience, but also can achieve better disassembly and mounting while ensuring connection stability between the flanges.

### BRIEF DESCRIPTION OF DRAWINGS

To more clearly describe the technical solutions of the embodiments of the present invention, the accompanying drawings required in the embodiments are described briefly below. It should be understood that the following accompanying drawings illustrate only some embodiments of the present invention and therefore should not be construed as a limitation on the scope thereof. For a person of ordinary skill in the art, other relevant accompanying drawings can also be obtained from these accompanying drawings without any creative effort.

FIG. 1 is a schematic front view of a nut type rotatable flange structure according to an embodiment of the present invention;

FIG. 2 is a schematic left view of a nut type rotatable flange structure according to an embodiment of the present invention;

FIG. 3 is a sectional view of a nut type rotatable flange structure according to an embodiment of the present invention taken along line A-A;

FIG. 4 is a schematic structural diagram of a nut loop and a second neck flange according to an embodiment of the present invention; and

FIG. 5 is a schematic structural diagram of a nut type rotatable flange combination tool according to an embodiment of the present invention.

### DESCRIPTION OF EMBODIMENTS

To make the objectives, technical solutions and advantages of the embodiments of the present invention clearer, the technical solutions in the embodiments of the present invention will be described clearly and comprehensively below with reference to the accompanying drawings in the embodiments of the present invention. Obviously, the embodiments described are some of, rather than all of, the embodiments of the present invention. Generally, assemblies of the embodiments of the present invention described and illustrated in the accompanying drawings herein may be arranged and designed in a variety of different configurations.

Therefore, the following detailed description of the embodiments of the present invention provided in the accompanying drawings is not intended to limit the scope of the present invention as claimed, but is merely representative of the selected embodiments of the present invention. All other embodiments obtained by a person of ordinary skill in the art based on the embodiments of the present invention without creative efforts shall fall within the protection scope of the present invention.

It should be noted that similar reference numerals and letters indicate similar items in the following accompanying drawings. Therefore, once an item is defined in one accompanying drawing, the item does not need to be further defined and explained in subsequent accompanying drawings.

In the description of the present invention, it should be noted that an orientation or positional relationship indicated by the term “center”, “upper”, “lower”, “left”, “right”, “vertical”, “horizontal”, “inner”, “outer”, or the like is based on the orientation or positional relationship shown in the accompanying drawings, or the orientation or positional relationship of products of the present invention that are usually placed in use, which is only for convenience of describing the present invention and simplifying the description, rather than indicating or implying that the device or element referred to must have a particular orientation and be constructed and operated in a particular orientation, and therefore should not be construed as limiting the present invention. In addition, the terms “first”, “second”, “third”, etc. are merely used for distinct description, and shall not be construed as indicating or implying relative importance.

In the description of the present invention, it should also be noted that, unless otherwise explicitly specified and limited, the terms “arrange”, “mount”, “connected”, and “connect” should be broadly understood. For example, the term may be a fixed connection, a detachable connection or an integral connection; and may be a direct connection, an indirect connection by using an intermediate medium, or internal communication between two elements. For a person of ordinary skill in the art, the specific meanings of the terms mentioned above in the present invention may be construed according to specific circumstances.

### Embodiment 1

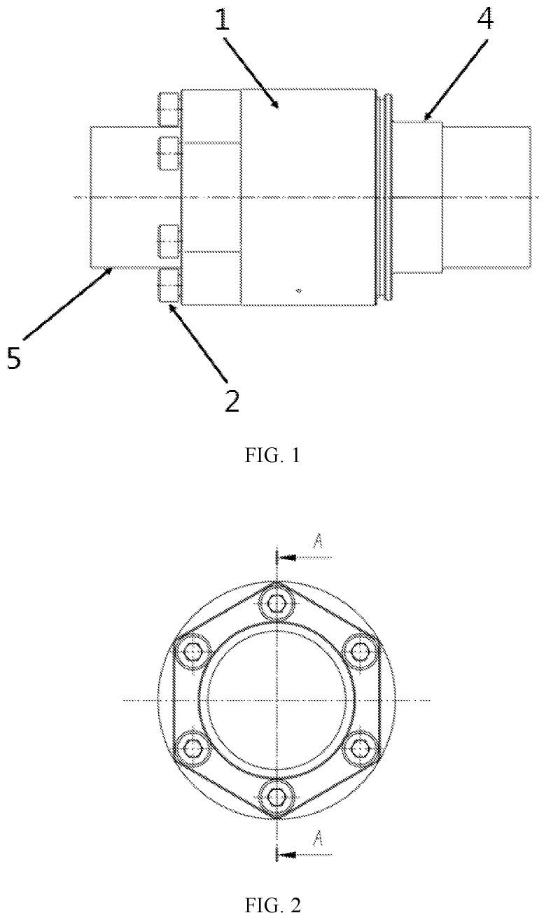

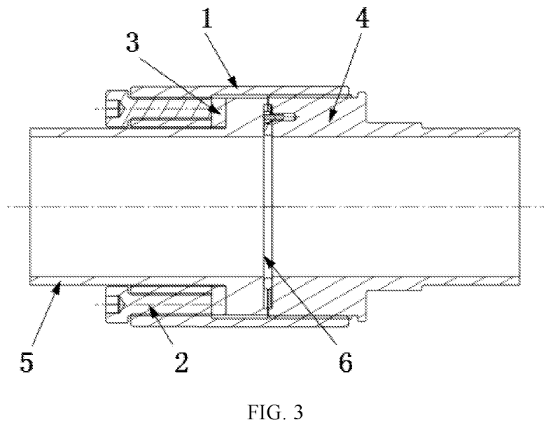

Referring to FIG. 1 to FIG. 3, a nut type rotatable flange structure provided in this embodiment mainly includes a nut loop 1, a first neck flange 5, a second neck flange 4, and push screws 2, where the first neck flange 5 and the second neck flange 4 mainly refer to flanges configured to connect to pipelines, and certainly, may refer to flanges connected to other components or platforms in other applicable scenes. The present application aims to form a structure that replaces the connection between conventional flanges, and components connected outside the flanges will not be described in detail.

In this embodiment, a connecting thread is machined on an inner surface of one end of the nut loop 1, an annular protruding edge 16 is formed on an inner surface of the other end of the nut loop, and threaded through holes 15 are machined in the annular protruding edge 16 in an axial direction of the nut loop 1. This means that the annular protruding edge 16 is formed in an inner space of the nut loop 1, and threaded through holes 15 running through end surfaces of two sides of the annular protruding edge 16 are machined in the annular protruding edge 16, and an axial direction of each threaded through hole 15 is the same as the axial direction of the nut loop 1. By using the above technical solution, a body portion of the nut loop 1 is formed, and the nut loop 1 is used as a positioning member to define a connection position or connection space of the first neck flange 5 and the second neck flange 4, instead of a conventional method in which the connection between flanges needs hole alignment depending on an external platform or manual auxiliary positioning.

A neck of the first neck flange 5 passes through an inner hole of the annular protruding edge 16, and an outer surface of the neck fits with the inner hole of the annular protruding edge 16. The mutual fit herein may refer to the hole-axis-type mutual fixed fit, such as interference fit, transition fit or clearance fit (mainly referring to clearance fit in general scenes), or may refer to hole-axis-type mutual running fit, that is, provided that a certain rotatable clearance is indicated, and rotation is performed in different applicable scenes to determine whether the first neck flange 5 needs to rotate relative to the nut loop 1. A flange portion of the first neck flange 5 is located in the inner hole of the nut loop 1, and an outer surface of the flange portion fits with the inner hole of the nut loop 1. The mutual fit mode herein is the same as the above-mentioned mutual fit mode, that is, whether the first neck flange 5 needs to rotate relative to the nut loop 1 can be determined according to needs of an applicable scene, and it can be concluded that the first neck flange 5 and the nut loop 1 are mainly coaxially arranged herein.

Similarly, the second neck flange 4 is mainly arranged coaxially with the nut loop 1. Specifically, an external thread is machined on an outer surface of a flange portion 42 of the second neck flange 4, the flange portion 42 fits with the connecting thread of the nut loop 1 by using the external thread of the flange portion, which means that the second neck flange 4 and the nut loop 1 are detachably fixed by using threaded connection, and the mutually connected portions are the flange portion 42 of the second neck flange 4 and the connecting thread at the end of the inner hole of the nut loop 1. A relative position relationship between the first neck flange 5 and the second neck flange 4 is determined through the arrangement of the nut loop 1. In this case, the connection sealing between the two flanges needs to be ensured. A sealing member 6 is arranged between the flange portion 42 of the second neck flange 4 and the flange portion of the first neck flange 5, which means that the sealing member 6 is arranged between end surfaces of the flanges on two sides that are in contact with each other, so as to ensure the sealing of the joint. It should be noted that the sealing member 6 may be a metal sealing ring or a plastic sealing ring, or may be a component made of a viscous material, or may be a sealing medium in some special application scenes, such as a sealing fluid (gas or liquid) medium, provided that the end surfaces of the flange portion 42 of the second neck flange 4 and the flange portion of the first neck flange 5 can squeeze each other to form a hermetical connection.

To achieve mutual squeezing and approaching between the first neck flange 5 and the second neck flange 4 so as to ensure the sealing therebetween, the push screws 2 are in threaded fit with the threaded through holes 15 in the annular protruding edge 16, which means that the push screws 2 are in threaded connection with the threaded through holes 15, and threaded ends of the push screws 2 can act on the flange portion of the first neck flange 5, so that the flange portion of the first neck flange 5, the flange portion 42 of the second neck flange 4 and the sealing member 6 are hermetically connected to each other. By means of the above technical solution, the push screws 2 only need to be screwed in, so that the push screws act on the flange portion of the first neck flange 5 to push the entire first neck flange 5 to move and approach the second neck flange 4, so as to squeeze the sealing member 6 to a certain extent between the first neck flange 5 and the second neck flange 4, and thus the sealing member 6 meets requirements for a pre-tightening force, thereby ensuring the connection sealing between the three. The use of the push screws 2 also does not need a conventional operation of aligning flange holes, but the push screws 2 only need to be tightened, which generates a strong pushing force. The pushing force and a reaction force on the nut loop 1 generate a strong clamping force on the first neck flange 5, so that the sealing member 6 is pre-tightened to achieve the sealing effect. In addition, the push screw 2 has a small friction diameter, and can achieve a high pushing force with a relatively small torque, thereby facilitating actual operation.

By using the main technical solution of the nut type rotatable flange structure in this embodiment, it can be concluded that, the solution is different from a conventional method of aligning one circle of flange holes with another circle of flange holes between two flanges and then sequentially screwing in connecting bolts (with nuts), and the conventional method needs repeated and accurate alignment between the flange holes, which is completed by a special supporting auxiliary tool for fitting while adjusting, or relies on pure manual positioning on two sides, thereby being relatively troublesome and complicated to some extent. In combination with the above-mentioned rotatable flange structure according to the present application, only the first neck flange 5 and the second neck flange 4 (with the sealing member 6) need to be sent or screwed into the nut loop 1, and finally the push screws 2 are screwed in from a single side, so that the flanges on two sides can be stably and hermetically connected without a complicated hole position alignment operation on the two sides, and an assembly operation can be completed directly by one person after machining according to accuracy requirements, thus avoiding the shortcomings of needing two persons or relying heavily on a special tool in the traditional method.

Generally, the nut type rotatable flange structure in this embodiment takes the nut loop 1 as the initial limiting component. After the nut loop 1 is positioned, the first neck flange 5, the sealing member 6 and the second neck flange 4 can be sequentially mounted, and finally the push screws 2 are screwed in. This not only is suitable for the assembly operation by a single person, but also achieves the whole convenient and fast assembly, can ensure the stability and sealing of the connection, can replace the conventional method of connecting flanges, and has a wide application prospect.

To alleviate hard damage between the threaded end (screwing end) of the push screw 2 and the flange portion of the first neck flange 5, the nut type rotatable flange structure further includes a hard washer 3, where the hard washer 3 is sleeved on the neck of the first neck flange 5, and the hard washer 3 is abutted against between the threaded end of the push screw 2 and the flange portion of the first neck flange 5. That is, the hard washer 3 acts as a force transmission intermediate member between the push screw 2 and the first neck flange 5, especially the threaded end of the push screw 2 directly acts on the hard washer 3, and the hard washer 3 transmits the corresponding squeezing force to the flange portion of the first neck flange 5 as a whole, so as to uniformly expand a stress area, thereby alleviating hard force damage of the flange portion of the first neck flange 5, and later maintenance can be performed by replacing the hard washer 3, thus ensuring the service life of the first neck flange 5. It should be noted that, for a person skilled in the art, the hard washer 3 usually refers to a steel structure with heat treatment hardness greater than HRC44, so it is only needed to determine a model of the hard washer according to applicable scenes and requirements, and details are not repeated herein.

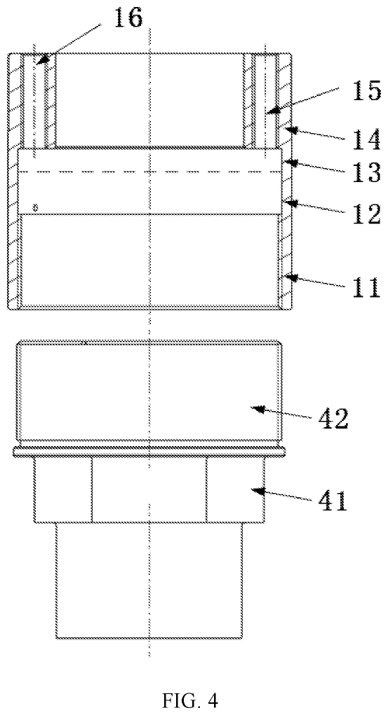

Referring to FIG. 4, to ensure effective interaction between the push screw 2, the hard washer 3, the first neck flange 5, and the second neck flange 4, in this embodiment, the inner hole of the nut loop 1 includes an internal thread section 11, a tool withdrawal groove section (including a first tool withdrawal groove section 12 and a second tool withdrawal groove section 13), and a protruding edge fitting section 14, which means that the inner hole of the nut loop 1 is sequentially divided into at least the above three parts for distinguishing and description. Specifically, the internal thread section 11 is configured to form the connecting thread, and the connecting thread is mainly used for threaded fit with the flange portion 42 of the second neck flange 4, so the internal thread section 11 is configured to fit with the flange portion 42 of the second neck flange 4, and it is preferable that the first neck flange 5 can be easily sleeved. The tool withdrawal groove section is configured to fit with the flange portion of the first neck flange 5 and the hard washer 3 (mainly the second tool withdrawal groove section 13 fits with the flange portion of the first neck flange 5, and the first tool withdrawal groove section 12 fits with the hard washer 3), and the tool withdrawal groove section is further configured to withdraw a cutter during machine tool manufacturing. The protruding edge fitting section 14 is configured to form the annular protruding edge 16. Similarly, the mutual fitting herein is the same as above, and relative fixed fitting or relative running fit is selected according to different applicable scenes.

The purpose of each part in the inner hole of the nut loop 1 is expounded. To achieve effective contact and functions of all parts in the inner hole, it is needed that the hard washer 3 can all act on the flange portion of the first neck flange 5, and the flange portion of the first neck flange 5 can all act on the flange portion 42 of the second neck flange 4 (the sealing member 6 functions to transmit forces), so as to improve directness and effectiveness of interaction between the push screw 2 and the hard washer 3, interaction between the hard washer 3 and the flange portion of the first neck flange 5, and interaction between the flange portion of the first neck flange 5 and the flange portion 42 of the second neck flange 4, and inhibit protrusions on an inner hole surface of the nut loop 1 from blocking or hindering smoothness of mutual contact between internal parts.

To further ensure contact stability between the threaded end of the push screw 2 and the hard washer 3, a solid lubricant coating is arranged on an end surface of at least one side of the hard washer 3. That is, the solid lubricant coating is arranged on an end surface of at least one of two sides of the hard washer 3, and functions to inhibit the first neck flange 5 from being driven to rotate when the nut loop 1 and the second neck flange 4 are relatively fastened, thereby improving lubrication performance and inhibiting the sealing between components from being greatly affected. For a person skilled in the art, it should be clear that the solid lubricant coating mainly refers to a composite material with high strength, high wear resistance and excellent self-lubricating performance that is prepared by adding solid lubricants (graphite, a soft metal, a layered solid, a fluoride, or a polymer), wear-resistant materials (a carbide, a nitride, and a silicide), oxidation-resistant materials (Ni—Mo—Al), and other components into metals (such as Fe-based, Ni-based, and Co-based), ceramics (SiO₂, ZrO₂, and Cr₂O₃) or nonmetallic materials (polytetrafluoroethylene, polyimide, polyether ether ketone, and ultra-high molecular weight polyethylene) as a matrix by using a certain process (hot-dip coating, electroplating, chemical plating or laser cladding), and thus details are not described herein.

Due to the technical solution of adding the solid lubricant coating, the lubricity between the hard washer 3 and the first neck flange 5 and/or between the hard washer 3 and the push screw 2 can be increased, thereby inhibiting a case that when there is a large fastening force, synchronous rotation is caused by excessive friction, resulting in the failure to perform further fastening. Certainly, according to different applicable scenes, the solid lubricant coating may be arranged on one side of the hard washer 3 close to the annular protruding edge 16, or the solid lubricant coating may be arranged on one side of the hard washer close to the second neck flange 4, or each of two sides of the hard washer 3 may be arranged with the solid lubricant coating, the purpose of increasing lubrication performance can be achieved no matter which form is used, and wear resistance between components can be improved.

By means of the above technical solution, especially the adding of the solid lubricant coating, when the second neck flange 4 is tightened after the initial pre-tightening of the push screw 2, a case that the first neck flange 5 is driven to rotate synchronously due to excessive friction, resulting in the failure to perform further fastening is inhibited, or a case that when the second neck flange 4 is fastened in place and the push screw 2 is further tightened, the first neck flange 5 and the second neck flange 4 are driven to rotate synchronously, resulting in the failure to perform further fastening is inhibited. Considering the practical operability, when the pre-tightening force is large enough and the friction of the solid lubricant coating also relatively becomes large, there is a very small chance that the first neck flange 5 and the second neck flange 4 rotate synchronously, resulting in the failure to perform further fastening. To further improve the limit of the pre-tightening force, a thread rotation direction of the connecting thread is opposite to a thread rotation direction of the threaded through hole 15. In this way, no matter how large the pre-tightening force is, the synchronous rotation between the first neck flange and the second neck flange due to an external force can be avoided, and sufficient connection stability between the two is ensured.

In addition, since there are tolerance clearances of fit between threads, to eliminate a lack of sealing caused by these clearances when machining accuracy is insufficient, a minimum clearance of fit between the threaded through hole 15 and the push screw 2 is defined as a first clearance, a minimum clearance of fit between the connecting thread and the external thread of the flange portion 42 of the second neck flange 4 is defined as a second clearance, and the size of the first clearance is greater than the size of the second clearance. That is, when the push screw 2 is tightened again, an external force can be applied to the push screw 2, and one of the originally same first clearances on two sides of a screw thread of the push screw has a size becoming larger, while the other first clearance becomes smaller (on one side in a force application direction). In this case, the second clearance on one side of a screw thread of the connecting thread becomes zero, which ensures that when the external force acts on the push screw 2, the external force can fully and effectively act on the second neck flange 4, thereby inhibiting a case that a part of the force causes the first clearance on one side of the push screw 2 to become zero in advance, so that the external force cannot be completely transmitted to the second neck flange 4 through the hard washer 3.

Furthermore, the solid lubricant coating can be elastically deformed in an axial direction of the hard washer 3 (the solid lubricant coating can recover after deformation), and the surface of the solid lubricant coating made of the above materials has certain elasticity, can be compressed in the axial direction under the action of the external force, and can recover automatically after the external force disappears. When the solid lubricant coating is arranged on an end surface of one side of the hard washer 3, a maximum deformation quantity of the elastic deformation generated by the solid lubricant coating on the one side is not less than a sum of the sizes of the first clearance and the second clearance; or when each of end surfaces of two sides of the hard washer is arranged with the solid lubricant coating 3, a maximum total deformation quantity of the elastic deformation generated by the solid lubricant coatings on the two sides is not less than the sum of the sizes of the first clearance and the second clearance. With reference to the above technical solution, when the external force is continuously applied to the push screw 2 for fastening, the second clearance on one side (one side in the force application direction) of the screw thread of the connecting thread first becomes zero, since the hard washer 3 does not generate enough deformation in this case and thus achieves the function of force transmission, when the second clearance on one side first becomes zero, the push screw 2 starts to compress the solid lubricant coating obviously to make the solid lubricant coating reach a maximum deformation quantity, until the first clearance on one side becomes zero, that is, it is impossible to further compress the solid lubricant coating, which means that all the threaded fit is in sealing contact in place and achieves the maximum sealing performance. However, since the seal is formed on the same side of the screw thread, the sealing performance will be reduced once the solid lubricant coating rebounds. During recovering, the solid lubricant coating gradually recovers from a maximum deformation position to an initial position. In this case, since the maximum deformation quantity of the solid lubricant coating is greater than or equal to the sum of the sizes of the first clearance and the second clearance, a sealing form of the same side of the two screw threads can be converted into a sealing form of opposite sides, and the maximum sealing performance is achieved again, thereby ensuring further sealing performance of the entire rotatable flange structure.

By using the above technical solution, a better hermetical connection is formed between the hard washer 3, the flange portion of the first neck flange 5, and the flange portion 42 of the second neck flange 4. To further achieve better sealing performance between the flange portion of the first neck flange 5 and the flange portion 42 of the second neck flange 4, positioning grooves are formed in one side of the flange portion of the first neck flange 5 and one side of the flange portion 42 of the second neck flange 4 that are close to each other, and a positioning space for accommodating the sealing member 6 is formed between the two positioning grooves. The positioning space herein matches the space of the sealing member 6 in shape, and needs to be just enough to accommodate the sealing member 6, so as to achieve contact sealing. In addition, the sealing member 6 is secured to the positioning groove in at least one side by using a connecting member, and the connecting member may be a bolt, a rivet, a magnet, an adhesive layer, etc., provided that the sealing member 6 can be stably connected to at least one positioning groove, so as to inhibit the sealing member 6 from being misaligned to result in unstable sealing when the positioning grooves on the two sides move close to each other for forming.

In addition, the flange portion of the first neck flange 5 and the flange portion 42 of the second neck flange 4 are usually in the form of a rotator. To inhibit stress concentration on a single side, uniform force application is needed to ensure the uniformity of force transmission. A plurality of threaded through holes 15 are provided, and the plurality of threaded through holes 15 are evenly distributed on the annular protruding edge 16 around an axis of the nut loop 1 in a circumferential direction, in the form shown in FIG. 2. A number of the push screws 2 is equal to a number of the threaded through holes 15, and single push screws 2 are in threaded fit with single threaded through holes 15. In this way, the purpose of comprehensive and balanced force of the entire flange structure during and after assembly can be ensured. In addition, to facilitate the application of the external force and the convenient disassembly and assembly of the entire flange structure, a boss portion 41 that can interact with a wrench is formed on an outer surface of a neck of the second neck flange 4; and/or a boss portion 41 that can interact with a wrench is formed on an outer surface of the nut loop 1.

By using the above technical solution, it can be concluded that the boss portion 41 that can interact with a wrench is formed on at least one of the outer surface of the neck of the second neck flange 4 and the outer surface of the nut loop 1. The boss portion 41 herein is mainly a rotary step with an angle, and can cooperate with different internal angle wrenches, such as an Allen wrench and a hexagonal boss, which can be secured to each other to facilitate a force application operation. When the boss portion 41 is formed on the outer surface of the neck of the second neck flange 4, the wrench directly secures the neck of the second neck flange 4, and then a rotation operation is performed, so that mutual fit between the flange portion 42 of the second neck flange 4 and the connecting thread can be achieved, and the nut loop 1 needs to be secured in this case. The nut loop 1 may be secured by another platform or tool. For example, other connecting members or connecting grooves are designed on the nut loop 1, and the connecting members or the connecting grooves are positioned by a special tool to ensure that the nut loop 1 does not rotate relatively. For another example, the boss portion 41 is formed on the outer surface of the nut loop 1, and is also secured by the wrench. This means that the boss portion 41 is provided in the two methods, and any method is available provided that the nut loop 1 relatively secured. Similarly, when the boss portion 41 is formed on only the outer surface of the nut loop 1, the boss portion is secured by the wrench, and then the second neck flange 4 is rotated by another platform or tool. As an alternative to this embodiment, a boss portion 41 is formed on the outer surface of the neck of the second neck flange 4, and the outer surface of the nut loop 1 can be secured by arranging a boss portion 41 or by another platform or tool.

### Embodiment 2

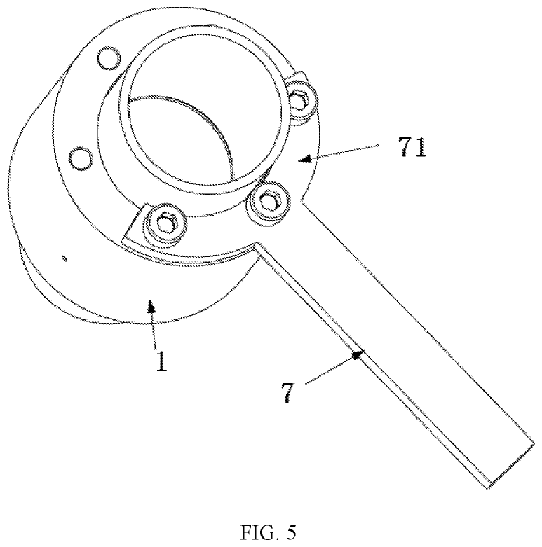

Referring to FIG. 5, this embodiment further provides a nut type rotatable flange combination tool, including an operating wrench 7 and the nut type rotatable flange structure described in Embodiment 1. It should be noted that the nut type rotatable flange structure in this embodiment is further defined and optimized based on the alternative solution of Embodiment 1, that is, the nut type rotatable flange structure is provided with a plurality of threaded through holes 15, and the plurality of threaded through holes 15 are evenly distributed on an annular protruding edge 16 around an axis of a nut loop 1 in a circumferential direction; a number of push screws 2 is equal to a number of the threaded through holes 15, single push screws 2 are in threaded fit with single threaded through holes 15, which is suitable for the form of the plurality of threaded through holes 15, and the rest is consistent with the selection range described in Embodiment 1. Moreover, a boss portion 41 is formed on an outer surface of a neck of a second neck flange 4 in this embodiment, and is used for the operating wrench 7 to achieve the purpose of relative fixation. Specifically, the operating wrench 7 includes an operating portion and a positioning portion 71 connected to the operating portion, and the positioning portion 71 can be fixed to at least two push screws 2, that is, the boss portion 41 is formed on the outer surface of the neck of the second neck flange 4, and the nut loop 1 is secured by another platform or tool. By using the above technical solution, the wrench and the boss portion 41 formed on the outer surface of the neck of the second neck flange 4 are mutually fixed, and are reliably connected, and the positioning portion 71 of the operating wrench 7 and at least two push screws 2 of the nut loop 1 are mutually fixed, so that the second neck flange 4 is independently secured to the nut loop 1, thereby facilitating a subsequent assembly operation. In addition, this method does not need the machining of other parts or other platforms on the nut loop 1. For example, the boss portion is formed on the nut loop 1, which reduces the machining difficulty, and avoids affecting the strength and performance of the nut loop 1 itself due to a shape change.

In addition, to improve convenience of operation, in this embodiment, the positioning portion 71 is provided with an arc-shaped clamping groove fitting with the outer surface of the neck of the first neck flange 4, and the arc-shaped clamping groove is used for pre-positioning with the neck of the first neck flange 4, but the arc-shaped clamping groove does not need to be in contact with the first neck flange 4, and only provides a function of preliminary positioning. At least two positioning holes are machined in the positioning portion 71, and the at least two positioning holes can be correspondingly sleeved with a same number of push screws 2 simultaneously, which means that a number of the positioning holes is the same as a number of the push screws 2, and there are at least two positioning holes and at least two push screws. Single positioning holes and single push screws 2 are sleeved with each other. In this way, the positioning portion 71 can be quickly matched and positioned with the push screws 2, thereby facilitating force application and fixation by the operating portion. The combination tool of this embodiment is relatively more convenient to operate, and is suitable for a case that the outer surface of the nut loop 1 is a cylindrical surface, so that the nut loop 1 can be machined and shaped at a lower cost.

The foregoing descriptions are merely preferred embodiments of the present invention and are not intended to limit the present invention, and various modifications and changes of the present invention may be made by a person skilled in the art. Any modifications, equivalent substitutions, improvements, and the like made within the spirit and principle of the present invention should fall within the protection scope of the present invention. It should be noted that the structures or components illustrated in the accompanying drawings are not necessarily drawn to scale, and descriptions of well-known assemblies, processing technologies and processes are omitted in the present invention to avoid unnecessarily limiting the present invention.

1. A nut type rotatable flange structure, comprising:
a nut loop, having a connecting thread on an inner surface of one end of the nut loop, an annular protruding edge formed on an inner surface of an other end of the nut loop, and threaded through holes disposed in the annular protruding edge in an axial direction of the nut loop;
a first neck flange, having a neck that passes through an inner hole of the annular protruding edge, an outer surface of the neck fitting with the inner hole of the annular protruding edge, and a flange portion located in an inner hole of the nut loop, an outer surface of the flange portion fitting with the inner hole of the nut loop;
a second neck flange, having an external thread on an outer surface of a flange portion of the second neck flange, the flange portion fitting with the connecting thread of the nut loop by the external thread of the flange portion, and a sealing member is arranged between the flange portion of the second neck flange and the flange portion of the first neck flange; and
a plurality of push screws, wherein the push screws are in threaded fit with the threaded through holes in the annular protruding edge, and threaded ends of the push screws are capable of acting on the flange portion of the first neck flange, so that the flange portion of the first neck flange, the flange portion of the second neck flange and the sealing member are hermetically connected to each other.

2. The nut type rotatable flange structure according to claim 1, further comprising a hard washer, wherein the hard washer is sleeved on the neck of the first neck flange, and the hard washer is abutted against the threaded end of the push screw and the flange portion of the first neck flange.

3. The nut type rotatable flange structure according to claim 2, wherein the inner hole of the nut loop comprises an internal thread section, a tool withdrawal groove section, and a protruding edge fitting section that are sequentially connected; and
the internal thread section is configured to form the connecting thread, the tool withdrawal groove section is configured to fit with the flange portion of the first neck flange and the hard washer, a washer fitting section is configured to fit with the hard washer, and the protruding edge fitting section is configured to form the annular protruding edge.

4. The nut type rotatable flange structure according to claim 2, wherein a solid lubricant coating is arranged on an end surface of at least one side of the hard washer.

5. The nut type rotatable flange structure according to claim 4, wherein a thread rotation direction of the connecting thread is opposite to a thread rotation direction of the threaded through hole, a minimum clearance of fit between the threaded through hole and the push screw is a first clearance, a minimum clearance of fit between the connecting thread and the external thread of the flange portion of the second neck flange is a second clearance, and the size of the first clearance is greater than the size of the second clearance; and
the solid lubricant coating is capable of generating elastic deformation in an axial direction of the hard washer, and when the solid lubricant coating is arranged on an end surface of one side of the hard washer, a maximum deformation quantity of the elastic deformation generated by the solid lubricant coating on the one side is not less than a sum of the sizes of the first clearance and the second clearance; or when each of end surfaces of two sides of the hard washer is arranged with the solid lubricant coating, a maximum total deformation quantity of the elastic deformation generated by the solid lubricant coatings on the two sides is not less than the sum of the sizes of the first clearance and the second clearance.

6. The nut type rotatable flange structure according to claim 1, wherein positioning grooves are formed in one side of the flange portion of the first neck flange and one side of the flange portion of the second neck flange that are close to each other, a positioning space for accommodating the sealing member is formed between the two positioning grooves, and the sealing member is secured to the positioning groove in at least one side by a connecting member.

7. The nut type rotatable flange structure according to claim 1, wherein a plurality of threaded through holes are provided, and the plurality of threaded through holes are evenly distributed on the annular protruding edge around an axis of the nut loop in a circumferential direction; a number of the push screws is equal to a number of the threaded through holes, and single push screws are in threaded fit with single threaded through holes, respectively.

8. The nut type rotatable flange structure according to claim 1, wherein a boss portion capable of interacting with a wrench is formed on an outer surface of a neck of the second neck flange; and/or
a boss portion capable of interacting with a wrench is formed on an outer surface of the nut loop.

9. A nut type rotatable flange combination tool, comprising an operating wrench and the nut type rotatable flange structure according to claim 1, wherein the nut type rotatable flange structure is provided with a plurality of threaded through holes, and the plurality of threaded through holes are evenly distributed on an annular protruding edge around an axis of the nut loop in a circumferential direction; a number of push screws is equal to a number of the threaded through holes, and single push screws are in threaded fit with single threaded through holes, respectively;
the operating wrench comprises an operating portion and a positioning portion connected to the operating portion, and the positioning portion is capable of being secured to at least two push screws; and
a boss portion capable of interacting with the wrench is formed on an outer surface of a neck of the second neck flange.

10. The nut type rotatable flange combination tool according to claim 9, wherein at least two positioning holes are disposed in the positioning portion, and the at least two positioning holes are capable of being correspondingly sleeved with a same number of push screws simultaneously.

11. A nut type rotatable flange combination tool, comprising an operating wrench and the nut type rotatable flange structure according to claim 2, wherein the nut type rotatable flange structure is provided with a plurality of threaded through holes, and the plurality of threaded through holes are evenly distributed on an annular protruding edge around an axis of the nut loop in a circumferential direction; a number of push screws is equal to a number of the threaded through holes, and single push screws are in threaded fit with single threaded through holes, respectively;

12. A nut type rotatable flange combination tool, comprising an operating wrench and the nut type rotatable flange structure according to claim 3, wherein the nut type rotatable flange structure is provided with a plurality of threaded through holes, and the plurality of threaded through holes are evenly distributed on an annular protruding edge around an axis of the nut loop in a circumferential direction; a number of push screws is equal to a number of the threaded through holes, and single push screws are in threaded fit with single threaded through holes, respectively;

13. A nut type rotatable flange combination tool, comprising an operating wrench and the nut type rotatable flange structure according to claim 4, wherein the nut type rotatable flange structure is provided with a plurality of threaded through holes, and the plurality of threaded through holes are evenly distributed on an annular protruding edge around an axis of the nut loop in a circumferential direction; a number of push screws is equal to a number of the threaded through holes, and single push screws are in threaded fit with single threaded through holes, respectively;

14. A nut type rotatable flange combination tool, comprising an operating wrench and the nut type rotatable flange structure according to claim 5, wherein the nut type rotatable flange structure is provided with a plurality of threaded through holes, and the plurality of threaded through holes are evenly distributed on an annular protruding edge around an axis of the nut loop in a circumferential direction; a number of push screws is equal to a number of the threaded through holes, and single push screws are in threaded fit with single threaded through holes, respectively;

15. A nut type rotatable flange combination tool, comprising an operating wrench and the nut type rotatable flange structure according to claim 6, wherein the nut type rotatable flange structure is provided with a plurality of threaded through holes, and the plurality of threaded through holes are evenly distributed on an annular protruding edge around an axis of the nut loop in a circumferential direction; a number of push screws is equal to a number of the threaded through holes, and single push screws are in threaded fit with single threaded through holes, respectively;

16. The nut type rotatable flange combination tool according to claim 11, wherein at least two positioning holes are disposed in the positioning portion, and the at least two positioning holes are capable of being correspondingly sleeved with a same number of push screws simultaneously.

17. The nut type rotatable flange combination tool according to claim 12, wherein at least two positioning holes are disposed in the positioning portion, and the at least two positioning holes are capable of being correspondingly sleeved with a same number of push screws simultaneously.

18. The nut type rotatable flange combination tool according to claim 13, wherein at least two positioning holes are disposed in the positioning portion, and the at least two positioning holes are capable of being correspondingly sleeved with a same number of push screws simultaneously.

19. The nut type rotatable flange combination tool according to claim 14, wherein at least two positioning holes are disposed in the positioning portion, and the at least two positioning holes are capable of being correspondingly sleeved with a same number of push screws simultaneously.

20. The nut type rotatable flange combination tool according to claim 15, wherein at least two positioning holes are disposed in the positioning portion, and the at least two positioning holes are capable of being correspondingly sleeved with a same number of push screws simultaneously.
